(19) United States
(12) Patent Application Publication
(10) Pub. No.: US 2003/0223356 A1
(43) Pub. Date: Dec. 4, 2003

(54) RF switch

(76) Inventor: Rack-June Baek, Seoul (KR)

Correspondence Address: MARK M. TAKAHASHI, GRAY CARY WARE & FREIDENRICH, LLP, 4365 EXECUTIVE DRIVE, SUITE 1100, SAN DIEGO, CA, 92121-2133, US

(21) Appl. No.: 10/157,264

(22) Filed: May 29, 2002

(51) Int. Cl. G08C 15/00

(52) U.S. Cl. 370/216; 714/4; 340/825.01

(57) ABSTRACT

A RF switch having a redundancy port and a control circuit for switching a port related with an abnormal signal path to the redundancy port while preventing another ports from being connected to the redundancy port when an additional abnormality breaks out in another signal path to minimize the negative effect on the system. The RF switch includes first series ports (A1-An); second series ports (B1-Bn) each being connected to respective one of said first series ports to form a signal path; a redundancy port (C) for replacing a port when an abnormality breaks out in one of the n signal paths; a plurality of switching units for selectively connecting one of said first series ports to corresponding one of said second series ports or to said redundancy port in response to a control signal; a control signal input terminal for receiving the control signal; and a control circuit for receiving an abnormality alarm signal from an abnormal path when an abnormality breaks out in the path, providing a first control signal for switching the port related with the abnormal path to the redundancy port, and providing a second control signal for switching only the port related with a first abnormal path to the redundancy port when abnormalities break out in more than one path.

### RELATED APPLICATION

This application claims priority of Canadian patent application serial number ______, filed Mar. 27, 2002.

### BACKGROUND OF THE INVENTION

1. Field of the Invention

The present invention relates to a radio frequency (RF) switch used in a base station of a wireless communications system and, more particularly, to a RF switch having a redundancy port and a control circuit for switching a port related with an abnormal signal path to the redundancy port while preventing another ports from being connected to the redundancy port when abnormalities break out in two or more signal paths.

2. Description of Related Arts

Generally, a RF switch includes a plurality of ports installed on a metallic housing of cylindrical or hexahedronal shape. Switch bars driven by electromagnets connect or disconnect the ports inside the housing.

FIG. 1A illustrates an example of an arrangement of ports in a conventional RF switch. In FIG. 1A, a plurality of ports A1, A2, . . . , An, B1, B2, . . . , and Bn are arranged radially, for example, with a redundancy port on the center. One A-series port and one B-series port given the same index are connected to each other. For example, the port A1 is connected to the port B1. One of two such ports may be used for input while the other port being used for output, or vice versa. The RF switch is installed in a pair in such a manner that one switch is installed in front of a power amplifier of a transmission stage of a communications equipment (e.g., a base station) which includes plural power amplifiers while the other switch is installed behind the power amplifier. When an abnormality breaks out in a signal path or a port, the port is connected to the redundancy port so that the system maintains its operation.

FIG. 1B is a sectional view of a switching unit which actually carries out the switching operation. A first and second electromagnets 111 and 112 are arranged symmetrically. A rotating segment 113 made of magnetizable material is installed below the electromagnets 111 and 112 so as to pivot around its center. The rotating segment 113 is driven by the electromagnets 111 and 112, and a plate spring 114 attached beneath the rotating segment 113 presses a first switching bar 116 or a second switching bar 117 to connect or disconnect a common terminal 118 to a switching terminal 119. The operation of the electromagnets 111 and 112 are controlled by control signals provided through control signal lines 120. The control signals provided to the electromagnets 111 and 112 are DC signals having the same magnitude but opposite polarity. While one of the electromagnets 111 and 112 is magnetized and pulls one end of the rotating segment 113, the other electromagnet is demagnetized. For example, when the first electromagnet 111 is magnetized and pulls the rotating segment 113, the plate spring 114 presses the second switching bar 117 so that the common terminal 118 is connected to the switching terminal 119. At this time, the first switching bar 116 is released by the return spring 115.

FIG. 1C is an exemplary application of the RF switch in a system. The system of FIG. 1C is comprised of an input side RF switch 11, an amplifying stage 12, and a output side RF switch 13. The input side RF switch 11 receives plural channels (Ch. 1-Ch. n) of signals and provide the signals to the amplifying stage 12, which amplifies the signals. The amplified signals are output through the output side RF switch 13. Each A-series port of the input side RF switch 11 receives respective channel of signal. Each A-series port is connected to a corresponding B-series port in the RF switches 111 and 13. A signal input through an A-series port of the input side RF switch 11 is provided to an amplifier of the amplifying stage 12 through a corresponding B-series port. The amplified signal is provided to a B-series port and output through a corresponding A-series port of the output side RF switch 13. Additional amplifier C is arranged between a redundancy port of the input side RF switch 11 and a redundancy port of the output side RF switch 13.

FIGS. 2A through 2C illustrate an example of a connection sequence according to the abnormality occurrences in a conventional multiple-connection RF switch. In FIGS. 2A through 2C, symbols [1], [2], and [3] denote sequences of operations or events. More specifically, [1] denotes a normal state, in which ports A1, A2, and An are connected to ports B1, B2, Bn, respectively. [2] denotes a state that an abnormality broke out in the path between the ports An and Bn and thus the port An is connected to the redundancy port C. [3] denotes a state that another abnormality broke out in the path between the ports A1 and B1 and thus the port A1 is also connected to the redundancy port C.

As can be seen in FIGS. 2A through 2C, the conventional multiple-connection RF switch has a drawback that, when plural abnormalities break out in two or more signal paths in a short time period, all the A-series ports pertaining to the abnormal paths are sequentially connected to the redundancy port, which may result in negative influence on the system performance.

FIGS. 3A through 3C illustrate an example of a connection sequence according to the abnormality occurrences in a conventional single-connection RF switch. In FIGS. 3A through 3C, symbols [1], [2], and [3] denote sequences of operations or events. [1] denotes a normal state, in which ports A1, A2, and An are connected to ports B1, B2, Bn, respectively. [2] denotes a state that an abnormality broke out in the path between the ports An and Bn and thus the port An is connected to the redundancy port C. [3] denotes a state that another abnormality broke out in the path between the ports A1 and B1 and thus the port A1 is connected to the redundancy port C while the port An connected to the redundancy port C is connected again to the port Bn.

As described above, when plural abnormalities break out in two or more signal paths in a short time period in the conventional single-connection RF switch, the port of the abnormal paths previously connected to the redundancy port is disconnected from the redundancy port, which may result in overload problem in the system.

### SUMMARY OF THE INVENTION

To address the above problems, the present invention provides a RF switch having a redundancy port and a control circuit for switching a port related with an abnormal signal path to the redundancy port while preventing another ports from being connected to the redundancy port when an additional abnormality breaks out in another signal path to minimize the negative effect on the system

A RF switch according to the present invention for achieving the above object is suitable for use in a wireless communications system. The RF switch includes first series ports (A1-An); second series ports (B1-Bn) each being connected to respective one of said first series ports to form a signal path; a redundancy port (C) for replacing a port when an abnormality breaks out in one of the n signal paths; a plurality of switching units for selectively connecting one of said first series ports to corresponding one of said second series ports or to said redundancy port in response to a control signal; a control signal input terminal for receiving the control signal; and a control circuit for receiving an abnormality alarm signal from an abnormal path when an abnormality breaks out in the path, providing a first control signal for switching the port related with the abnormal path to the redundancy port, and providing a second control signal for switching only the port related with a first abnormal path to the redundancy port when abnormalities break out in more than one path.

Thus, the RF switch of the present invention, having a redundancy port, switches a port related to an abnormality to the redundancy port while preventing another ports from being connected to the redundancy port and minimizing the effect on overall a system performance.

### BRIEF DESCRIPTION OF THE DRAWINGS

The above objectives and advantages of the present invention will become more apparent by describing in detail preferred embodiments thereof with reference to the attached drawings in which:

FIG. 1A illustrates an example of an arrangement of ports in a conventional RF switch;

FIG. 1B is a sectional view of a switching unit;

FIG. 1C is an exemplary application of the RF switch in a system;

FIGS. 2A through 2C illustrate an example of a connection sequence according to the abnormality occurrences in a conventional multiple-connection RF switch;

FIGS. 3A through 3C illustrate an example of a connection sequence according to the abnormality occurrences in a conventional single-connection RF switch;

FIG. 4 illustrates a 4-way RF switch according to an embodiment of the present invention;

FIG. 5 is a circuit diagram of a control circuit of the 4-way RF switch according to an embodiment of the present invention; and

FIGS. 6A through 6C are exterior views of the RF switch according to the present invention.

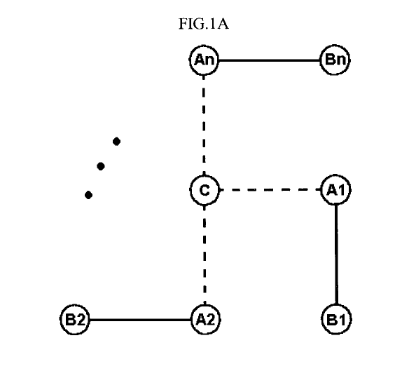

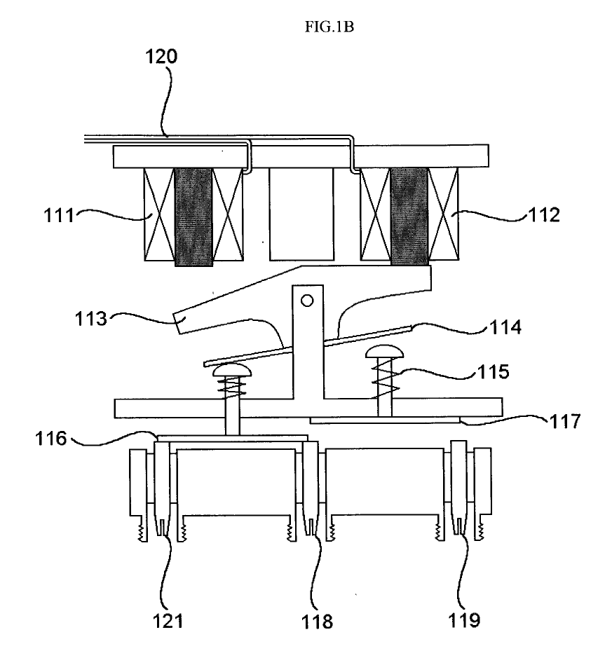

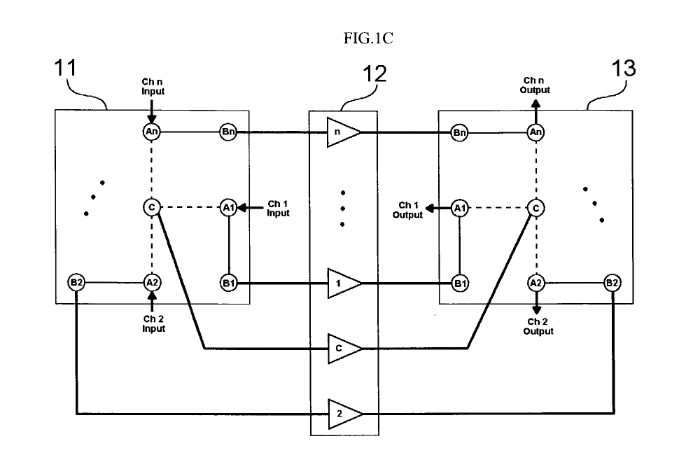

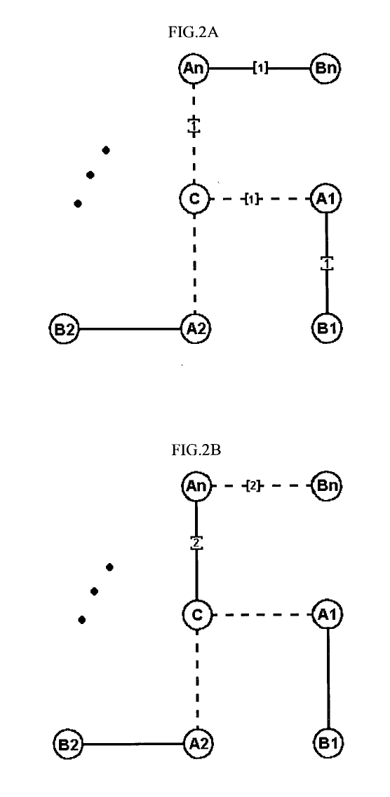

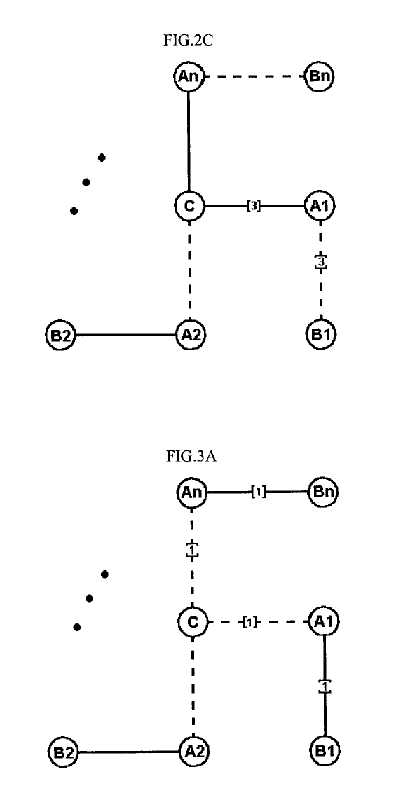

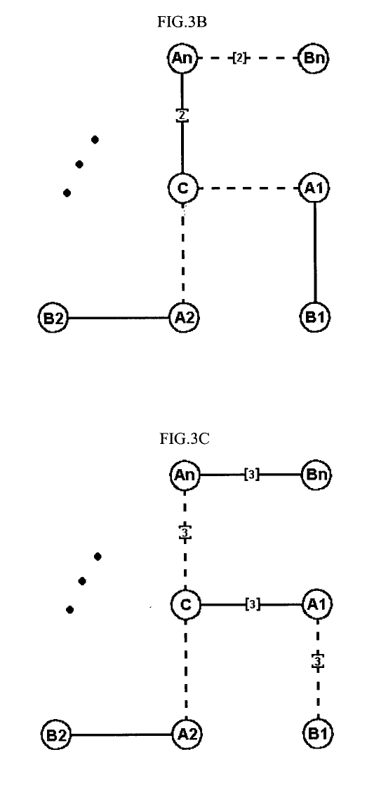

### DETAILED DESCRIPTION OF PREFERRED EMBODIMENTS

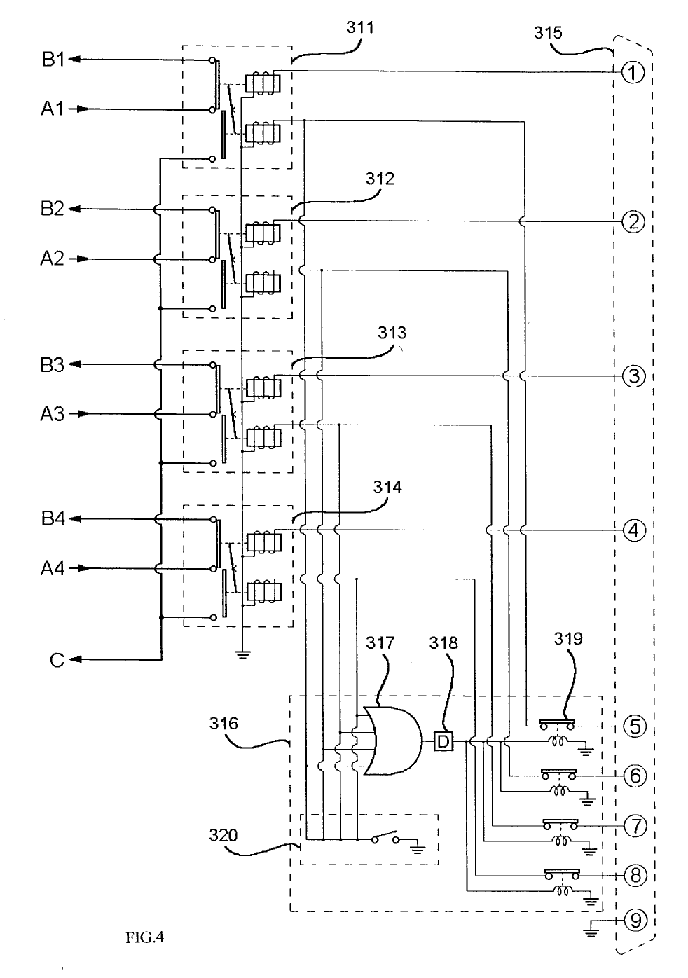

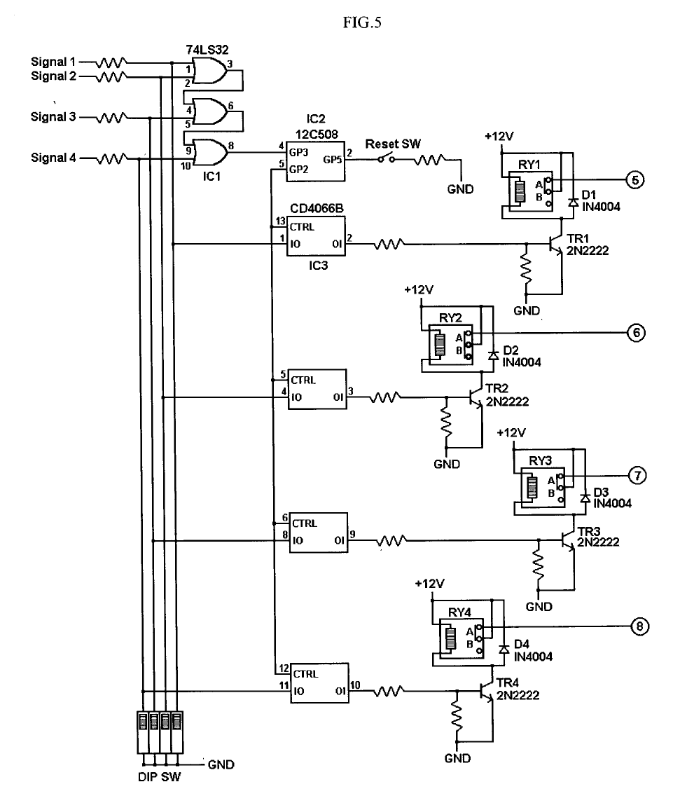

Referring to FIG. 4, a 4-way switch according to an embodiment of the present invention includes four A-series ports, four B-series ports, and one redundancy port C. Each pair of one A-series port and B-series port is connected to respective one of a first through a fourth switching units 311 through 314. The first through the fourth switching units 311 through 314 can be connected to the redundancy port C according to a first control signal input through a control signal input terminal 315. Also, the first control signal is provided to fifth through eighth pins of the control signal input terminal 315.

After the control circuit 316 connects only one of the four paths to the redundancy port C in response to the first control signal, the fifth through eighth pins of the control signal input terminal 315 are isolated from the control circuit 316. Thus, when the abnormalities break out in two or more paths within a short time period, the control circuit 316 prevents the first control signal from being provided to the switching units so as to minimize the effect of the system performance.

The operation of the circuit of FIG. 4 will be described in more detail. In a normal state, the A-series port and the B-series port in each of the first through the fourth switching units 311 through 314 is connected to each other. Also, all the four switches 319 in the control circuit 316 are turned on, so that the fifth through the eighth pins of the control signal input terminal are connected to the first through the fourth switching units 311 through 314, respectively.

Contrarily, when an error occurs in one of the four signal paths, the control circuit receives an abnormality alarm signal and provides the first control signal to a switching unit corresponding to the abnormal path to switch the path to the redundancy port. For example, when an abnormality occurs in the first path, the control circuit applies the first control signal to the fifth pin of the control signal input terminal 315, so that the first path is switched to the redundancy port, that is, the port A1 is connected to the redundancy port C. Simultaneously, since the digital logic of signal line connected to the first switching unit is high, the OR gate 317 of the control circuit 316 turns off four switches 319 which receives a second control signal from the OR gate 317. Thus, the fifth through the eighth pins in the control signal input terminal 315 are isolated from the circuit. Here, Table 1 summarizes the interconnected port pair according to the pin to which the control signal is applied in the control signal input terminal 315.

TABLE 1
Switching Control Signal Input Pins and Related Port Pairs

| Pin Number | Interconnection of Port Pair |
|---|---|
| 1 | A1-B1 |
| 2 | A2-B2 |
| 3 | A3-B3 |
| 4 | A4-B4 |
| 5 | A1-C |
| 6 | A2-C |
| 7 | A3-C |
| 8 | A4-C |
| 9 | common ground |

Next, we consider a case that abnormalities occur in two of the four paths with a short time interval. For example, we assume that an abnormality occur in the first path and it is followed by another abnormality in the second path. The control circuit 316 applies the first control signal to the fifth pin of the control signal input terminal 315 to switch the first path to the redundancy port C. Simultaneously, since the digital logic of signal line connected to the first switching unit is high, the four switches 319 connected to the OR gate 317 is turned off by the second control signal from the OR gate 317. Thus, the fifth through the eighth pins in the control signal input terminal 315 are isolated from the circuit, and the second path is not connected to the redundancy port C.

A delay unit 318 is provided between the output terminal of the OR gate and the switches 319 considering that the OR gate receives, as inputs, the control signals for switching the abnormal path to the redundancy port C. The delay unit 318 gives some time delay to the output signal of the logic sum circuit, so that the switches 319 are turned off after the abnormal paths is solidly switched to the redundancy port C.

A reset unit 320, which can connect the input terminals of the OR gate to ground simultaneously, initializes the RF switch of the present invention. The reset unit 320 is used for recovering the RF switch to an initial or normal state after the breakout of an abnormality. Also, the reset unit 320 may be used for a functional test in the production line of the RF switch.

FIG. 5 shows the control circuit of the 4-way RF switch according to an embodiment of the present invention, in detail. The signals, SIGNAL1 through SIGNAL4, are alarm signals informing the abnormalities of the four paths. An integrated circuit chip IC1, which implements the OR gate, responds to any one of the signals, SIGNAL1 through SIGNAL4. An integrated circuit chip IC2 connected to the chip IC1 gives some time delay to the output signal of the chip IC1 as mentioned above. The integrated circuit chip IC3 provides signals for blocking the signals, SIGNAL1 through SIGNAL4, to switching components TR1 through TR4, so that the switching components TR1 through TR4 drive relays RY1 through RY4 to isolate the fifth through eighth pins of the input terminal from the circuit.

To be more specific, in a normal-state, the first control signal is provided to the first through the fourth pins of the control signal input terminal 315 and the switching circuits 311 through 314 connect their A-series ports to their B-series port. Also, all the switches 319 in the control circuit 316 is turned on, so that the fifth through the eighth pins of the control signal input terminal 315 are connected to the first through the fourth switching unit, respectively. When an abnormality breaks out in the first path, for example, the SIGNAL1 informing the abnormality is provided to the first pin of the integrated circuit chip IC1 (74LS32 in this embodiment), and a voltage level of +12V is applied to the fifth pin of the control signal input terminal 315. Thus, the port A1 is connected to the port C and the first path is switched to the redundancy port.

At this time, the integrated circuit chip IC1 outputs digital logic high through its eights pin to the fourth pin of the chip IC2 (12C508 in this embodiment) in response to the SIGNAL1 which is input through the first pin of the chip IC1. Then, the second control signal is output from the fifth pin of the chip IC2 to the thirteenth, fifth, sixth, and twelfth pins of the chip IC3. The control signal is input to the thirteenth, fifth, sixth, and twelfth pins of the chip IC3 (CD4066B in this embodiment) and output from the second, third, ninth, and tenth pins of the chip IC3 to drive transistors TR1 through TR4 (2N2222 in this embodiment) and operate the relays RY1 through RY4 (TK1-12V in this embodiment). Thus, the four switches 319 are turned off and the fifth through eighth pins of the control signal input terminal 315 is isolated from the circuit.

As mentioned above, it is possible to tap the four inputs of the OR gate to connect to ground. Here, a DIP switch may be provided to each path to perform the functional test for each path. Further, the reset unit for connecting the second pin of the chip IC2 to ground may be further provided to initialize the RF switch of the present invention.

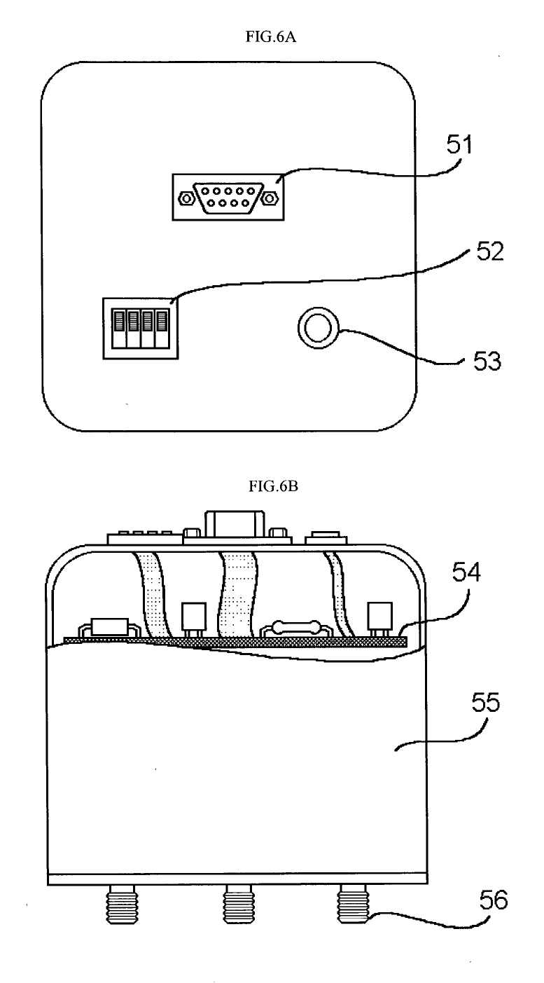

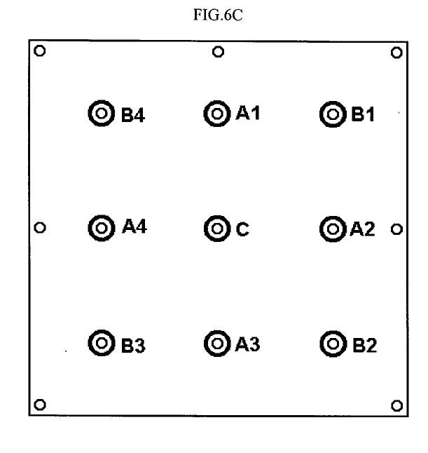

FIGS. 6A through 6C are exterior views of the RF switch according to the present invention. The RF switch has, on its top exterior surface, a control signal input terminal 51, a DIP switch 52 for performing the functional test for each path, and a reset unit 53 for the initialization. A printed circuit board 54 including the control circuit is installed in interior upper portion of the housing 55. A switching unit (not shown in the figure) is installed in interior lower portion of the housing, and a plurality of connectors 56 are installed beneath the bottom surface of the housing 55.

Although the present invention has been described in detail above, it should be understood that the foregoing description is illustrative and not restrictive. For example, the 4-way RF switch described above can be generalized to n-way RF switch by providing more connectors radially and expanding the control circuit. Thus, those of ordinary skill in the art will appreciate that many obvious modifications can be made to the invention without departing from its spirit or essential characteristics. Thus, it should be apparent that the invention can be modified in arrangement and detail without departing from such principles. We claim all modifications and variation coming within the spirit and scope of the following claims.

What is claimed is:

1. A RF switch for use in a wireless communications system, comprising:
first series ports (A1-An);
second series ports (B1-Bn) each being connected to respective one of said first series ports to form a signal path;
a redundancy port (C) for replacing a port when an abnormality breaks out in one of the n signal paths;
a plurality of switching units for selectively connecting one of said first series ports to corresponding one of said second series ports or to said redundancy port in response to a control signal;
a control signal input terminal for receiving the control signal; and
a control circuit for receiving an abnormality alarm signal from an abnormal path when an abnormality breaks out in the path, providing a first control signal for switching the port related with the abnormal path to the redundancy port, and providing a second control signal for switching only the port related with a first abnormal path to the redundancy port when abnormalities break out in more than one path.

2. The RF switch as claimed in claim 1, further comprising:
a housing enclosing the control circuit for providing the first control signal for switching the port related with the abnormal path to the redundancy port.

3. The RF switch as claimed in claim 1, further comprising:
a housing enclosing the control circuit for providing the second control signal for switching only the port related with the first abnormal path to the redundancy port when abnormalities break out in more than one path.

4. The RF switch as claimed in claim 1, wherein the control circuit comprises:
an OR gate for receiving one of the alarm signals (SIGNAL1-SIGNALn) informing the abnormal path and outputting a digital logic level of high;
means for delaying an output signal of said OR gate for a predetermined time;
switching components (TR1-TRN) operating according to an output signal of said delaying means;
relays (RY1-RYn) each being connected to respective one of said switching components (TR1-TRn); and
a DIP switch for selectively connecting the inputs of said OR gate to ground and facilitating functional test of each path; and
means for initializing said RF switch.
